(19) United States
(12) Patent Application Publication
(10) Pub. No.: US 2002/0120523 A1
(43) Pub. Date: Aug. 29, 2002

(54) On-line sale process using a computer and a system for the same

(76) Inventor: Chen-Shi Yang, Shi-Chih City (TW)

Correspondence Address: DOUGHERTY & TROXELL, Suite 1404, 5205 Leesburg Pike, Falls Church, VA, 22041, US

(21) Appl. No.: 09/791,713

(22) Filed: Feb. 26, 2001

(51) Int. Cl. G06F 17/60

(52) U.S. Cl. 705/26; 705/27; 705/80

(57) ABSTRACT

An on-line sale process using a computer and a system for the same are provided, in which a business web site is set up in a server of a enterprise, such that the enterprise can go on line to purchase what they want from the clients. The web site mainly has a client trading system that allows a plurality of clients going on line to register their basic information and the products the they want to purchase. The client trading system of the present invention includes an inquiry management system, a product trading management system, an inquiry/negotiation management system and a purchase order searching management system. The present invention can provide an electronic trade platform that simplifies sale process and related information to reduce the management cost for sale and human resource.

### BACKGROUND OF THE INVENTION

1. Field of Invention

The present invention relates to an on-line sale process using a computer and the system for the same. More particularly, the present invention relates to an on-line sale process and a system for the same, in which all of the products available from the clients are integrated and the enterprise can trade with the clients on line. With a platform provided by the present invention, not only an enterprise can trade with clients on the web, but also integrate the management after trading.

2. Description of the Related Art

The e-shopping trading model may be so far widespread, but it only show the products of the enterprise on a business web site. Consequently, its advantage is limited to the reduction of the shop-window and replacement of the shop cost. The whole trading management of the enterprise thus still needs to rely on communication between products management, manufactures, purchases and accountant departments. Moreover, although many sale-stock software applications are available, but most of them provide only data records and paperwork management functionality, while crucially missing the functionality of information analysis and decision propositions. As a result, the above-mentioned communication between sales, management, and accounting cannot be entirely eliminated and must performed inside the enterprise, causing the enterprise not to be able to make the correct decisions at crucial moment, which affects the adaptation ability of the enterprise.

### SUMMARY OF THE INVENTION

A major aspect of the present invention is to provide a online sale process using a computer, and a system for the same, wherein there are provided a simplified sale process and opened price inquiry information, such that the human resource management cost is reduced.

Another aspect of the present invention is to provide a on-line sale process by using a computer, and a system for the same, wherein the sale process management efficiency can be improved, while the employ of internet permits an opening to the international market, which benefits to the product sales and the enterprise innovation.

Yet, another aspect of the present invention is to provide an on-line sale process by using a computer, and a system for the same, wherein the resources related to the enterprise and clients are integrated through the employ of a web site to achieve a replenishment/sale/stock management.

Further, another aspect of the present invention is to provide a on-line sale process by using a computer, and a system for the same, wherein an analysis of the information related to clients can be quickly carried out to provide strategy proposition.

### BRIEF DESCRIPTION OF THE DRAWINGS

The objects, features and advantages of the present invention will be better understood through the following detailed description with the help of the accompanying drawings, wherein:

FIG. 1 is a schematic diagram showing a configuration of on-line trading according to the present invention;

FIG. 2 is a block diagram showing an on-line sale process by using a computer and a system for the same according to the present invention;

FIG. 3 is a flowchart showing product inquiry made by clients according to the present invention;

FIG. 4A is a flowchart showing the management of the product inquiry between the enterprise and the clients;

FIG. 4B is a flowchart showing the management of the inquiry/negotiation record for the clients according to the present invention;

FIG. 5A is a flowchart showing the management of client' purchase demand for the enterprise according to the present invention;

FIG. 5B is a flowchart showing that the clients performs advanced searching according to the price about the product arrangement provided by the enterprise;

FIG. 6A is a flowchart showing purchase order management system according to the present invention; and

FIG. 6B is a flowchart showing the account receivable management system according to the present invention.

### DETAILED DESCRIPTION OF THE INVENTION

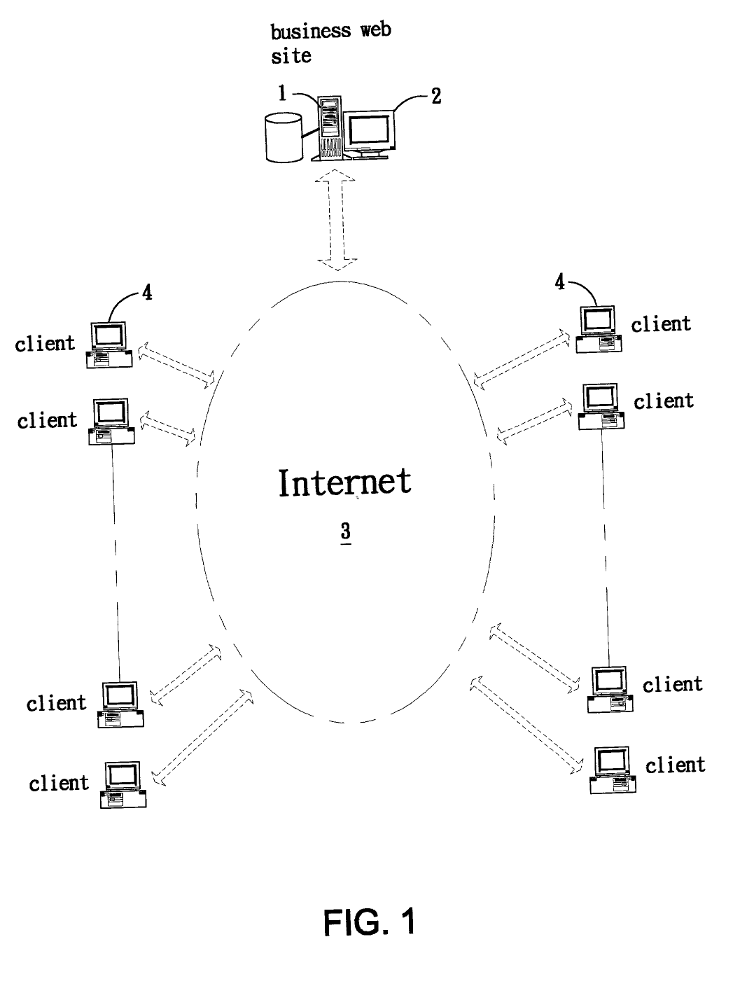

FIG. 1 is a schematic diagram showing a configuration of on-line sale according to the present invention. In the on-line sale process using a computer and a system for the same according to the present invention, a business web site 2 is set up in a server 1 of a enterprise, such that the enterprise can go on line through internet 3 to trade with any of clients 4. Each of the clients 4 can also connect to internet 3 and register into the web site 2 to trade with the enterprise. The web page format of the web site 2 can be written in a conventional language such as HTML, JAVA SCRIPT, SQL, and JSP, and includes the use of conventional cast structure, object-oriented technology and interactive interface. The hardware that is employed to connect to internet comprises computers, modems, xDSL modems, cable modems, ADSL, etc, while the software that are used comprises a web page browser and an e-mail sender/receiver.

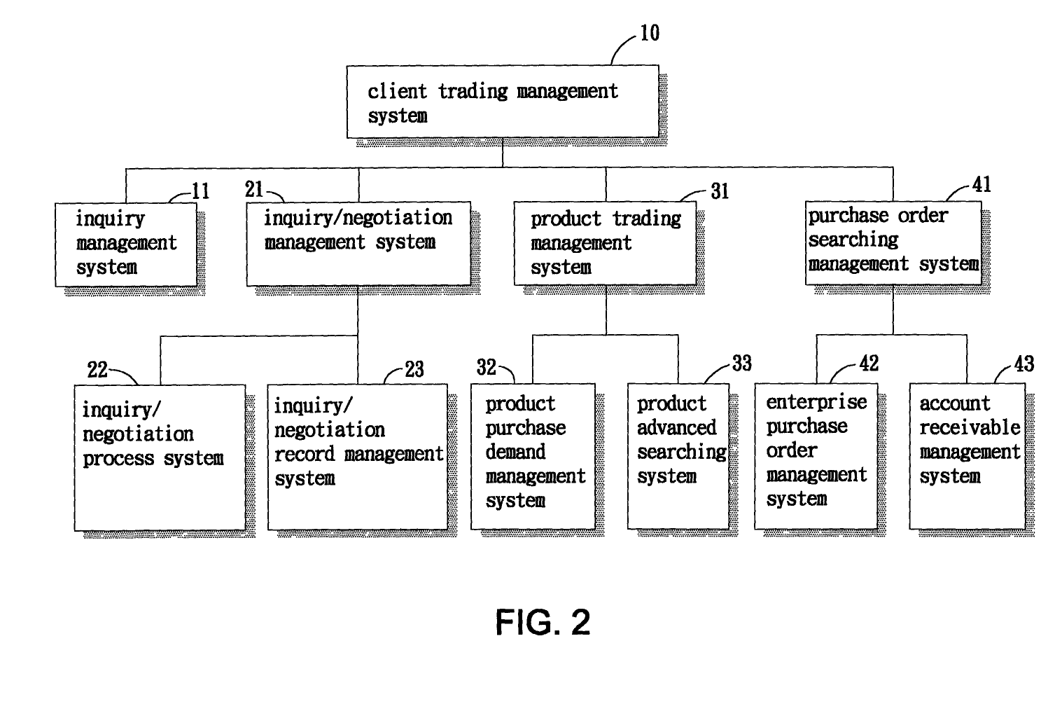

FIG. 2 is a block diagram showing an on-line sale process by using a computer and a system for the same according to the present invention. In a preferred embodiment of the present invention, a business web site 2 is built up in a server 1 of an enterprise. The business web site 2 includes introduction about the enterprise, production information and a client trading management system 10. The system 10 allows a plurality of clients 4 to register on line their basic information and the products they want to purchase. Once a client registers on line, the information is automatically saved in the server 1, such that executive operation can be done without input of its basic information again when the registered client visits the site next time.

The client trading management system 10 of the present invention includes an inquiry management system 11, an inquiry/negotiation management system 21, a production trading management system 31, and an purchase order searching management system 41. The inquiry management system 11 is a management system that provides inquiry of the products sold by the enterprise for the clients. The inquiry management system 11 advantageously provides following functions:

1. All the products the client wants to purchase are listed on the inquiry and put into an inquiry bag for the enterprise to provide an inquiry according to the selected products.

2. The enterprise can voluntarily put an inquiry into an inquiry bag for the client after arranging the products to be sold.

3. The enterprise can provide the client with an inquiry according to the products the client purchases periodically or wants to purchase.

In the client trading management system 10 of the present invention, the inquiry/negotiation management system 21 manages the inquiry and negotiation between the client and the enterprise. The inquiry/negotiation trading management system 21 further includes an inquiry/negotiation process system 22 and an inquiry/negotiation record management system 23. The inquiry/negotiation trading management system 21 allows the client negotiating with the enterprise for the inquiry, and allows the client recording either the inquiry/negotiation in question or special trades as well for other trade or for further re-negotiation.

In the client trading management system 10, the product trading management system 31 manages the products that the clients want to purchase. The product trading management system 31 further includes a product purchase demand management system 32 and a product advanced searching system 33. The product trading management system 31 advantageously provides the following functions:

1. After selecting and arranging the products, the client can provide the enterprise with an inquiry.

2. The enterprise can watch the products the clients purchased periodically or the products the enterprise can purchase for the client.

3. Either the product trading management system 31 can automatically take down what the enterprises purchased or the enterprises can input what they need into the product trading management system 31 such that the enterprise can provide the inquiry, according on the demand of the enterprise.

In the client trading system 10 of the present invention, the purchase order searching management system 41 is used for the client to manage the purchase order made by the enterprise. The purchase order searching management system 41 further includes an enterprise purchase order management system 42 and an account receivable management system 43. The purchase order searching management system 41 manages the purchase order post process, such as delivering of the products and reminder of the account.

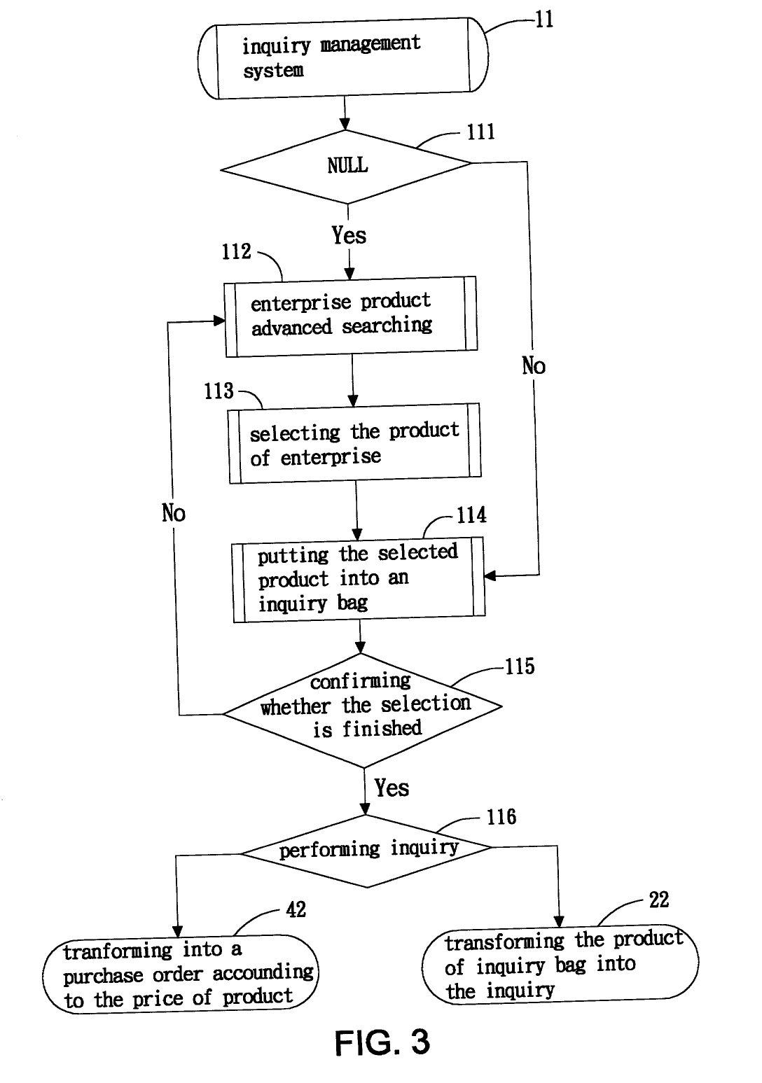

FIG. 3 is a flowchart showing product inquiry made by clients according to the present invention. The inquiry management system 11 of the present invention is used for the client to perform inquiry. The inquiry trading includes the steps of:

(a) confirming whether the inquiry is fulfilled or empty. If the inquiry is not empty, then go to step (d). Otherwise, go to the next step;

(b) entering the enterprise product advanced searching (step 112). When the client inputs the product name or product code or clicks a product icon, all of the information related to the product such as product name, product specification, amount, prices etc are listed;

(c) selecting the product item to be listed on the inquiry this time (step 113);

(d) putting the selected product item into the inquiry bag (step 114);

(e) confirming whether the selection is finished or not. If not finished, repeat step (b) to step (e). If finished, go to the next step; and

(f) transforming the product item of the inquiry bag into an inquiry, and saving it in the server 1 to run the inquiry/negotiation process system 22.

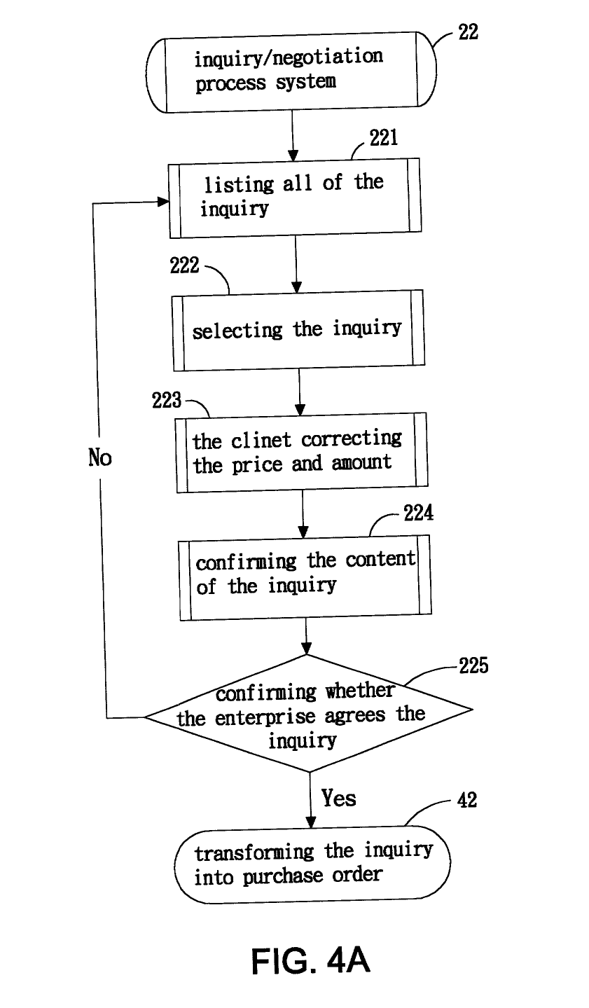

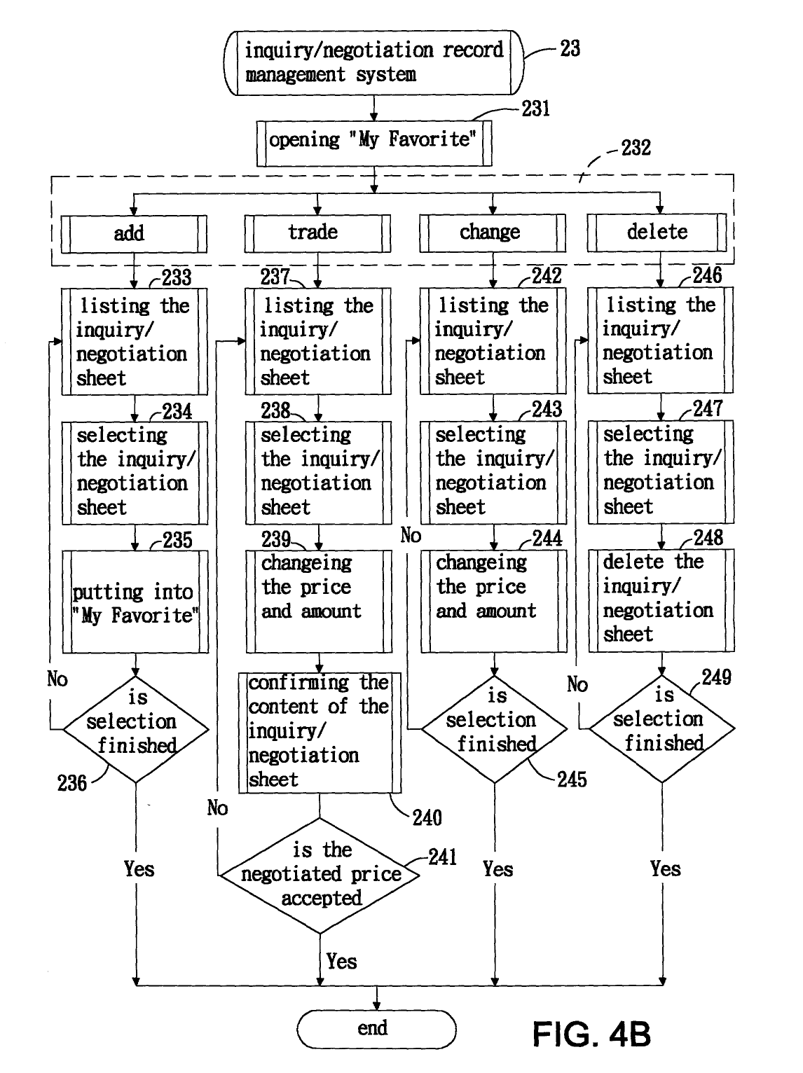

FIG. 4A is a flowchart showing the inquiry/negotiation according to the present invention. The inquiry/negotiation process system 22 of the present invention allows the client negotiating with the enterprise for the inquiry. The inquiry/negotiation process system 22 is execute in the following steps:

(a) listing all of the inquiries saved in the server 1 (step 221);

(b) The client selecting the inquiry to be inquired or negotiated (step 222);

(c) The client changing the amount and the price of the product item listed on the inquiry (step 223);

(d) confirming whether the content of the inquiry is correct. If not correct, then correct the inquiry. If correct, then transform the inquiry into the inquiry/negotiation sheet and save it in the server 1 (step 224).

(e) confirming whether the enterprise agrees with the inquiry/negotiation sheet. If no, then repeat step (a) to step (e). If yes, then go to the next step 225;

(f) transforming the inquiry/negotiation sheet into purchase order and saving it in the server 1 to run the enterprise purchase order management system 42.

FIG. 4B is a flowchart showing the inquiry/negotiation record management according to the present invention. Since numerous clients and trade records are saved in the server, many inquiry/negotiation sheet records may be obtained when searching, resulting in wasting time on searching the inquiry wanted. Therefore, with the system of the present invention, either the inquiry/negotiation sheets on inquiry/negotiation are saved, or the inquiry/negotiation for special trades, such as urgent cases, is saved for next-time trade or re-negotiation. Each client are allowed to use their “My Favorite” to manage the records of the inquiry/negotiation sheet. The inquiry/negotiation record management provides the following functions:

1. The inquiry/negotiation sheet can be added to “My Favorite”;

2. The inquiry/negotiation sheet in “My Favorite” can be clicked to perform inquiry/negotiation.

3. The inquiry/negotiation sheet in “My Favorite” can be corrected.

4. The inquiry/negotiation sheet in “My Favorite” can be deleted.

The inquiry/negotiation sheet record management system 23 is executed in the following steps:

(a) opening “My Favorite” (step 231);

(b) selecting the operation to be carrier out (step 232): If select “add”, then go to step (c). If select “trade”, then go to step (g). If select “correct”, then go to step (m). If select “delete”, then go to step (q);

(c) listing the inquiry/negotiation sheet saved in the server 1 (step 233).

(d) selecting the inquiry/negotiation sheet to be saved (step 234);

(e) putting the inquiry/negotiation sheet to be saved into “My Favorite” (step 235);

(f) confirming whether the selection is finished (step 236) or not. If not finished, then go to step (c) to (f). If finished, then save “My Favorite” in the server 1 to finish the operation of “add”;

(g) listing the inquiry/negotiation sheet saved in the server 1 (step 237).

(h) selecting the inquiry/negotiation sheet to be saved (step 238);

(i) changing the price and the amount of the product item listed in the inquiry/negotiation sheet (step 239);

(j) confirming the content of the changed inquiry/negotiation sheet is correct. If not correct, then correct it. If correct, then save the inquiry/negotiation sheet in the server 1 (step 240);

(k) confirming the enterprise agrees with this inquiry/negotiation sheet. If no, then repeat steps (G) to (k). If yes, then go to the next step 241;

(l) Transforming the inquiry/negotiation sheet into purchase order and saving it in the server 1 to run the enterprise purchase order management system 42;

(m) listing all the inquiry/negotiation sheets saved in “My Favorite” (step 242);

(n) selecting the inquiry/negotiation sheet needed to be changed (step 243);

(o) changing the price and amount of the product item in the inquiry/negotiation (step 244);

(p) confirming the selection is finished (step 245). If not finished, then go to step (m) to (p). If finished, then save “My Favorite” in the server 1 to finish the operation of “change”;

(q) listing the inquiry/negotiation sheet saved in “My Favorite” (step 246);

(r) selecting the inquiry/negotiation sheet to be deleted (step 247);

(s) deleting the selected inquiry/negotiation sheet (step 248);

(t) confirming the selection is finished (step 249). If not finished, then go to step (q) to (t). If finished, then save “My Favorite” in the server 1 to finish the operation of delete”.

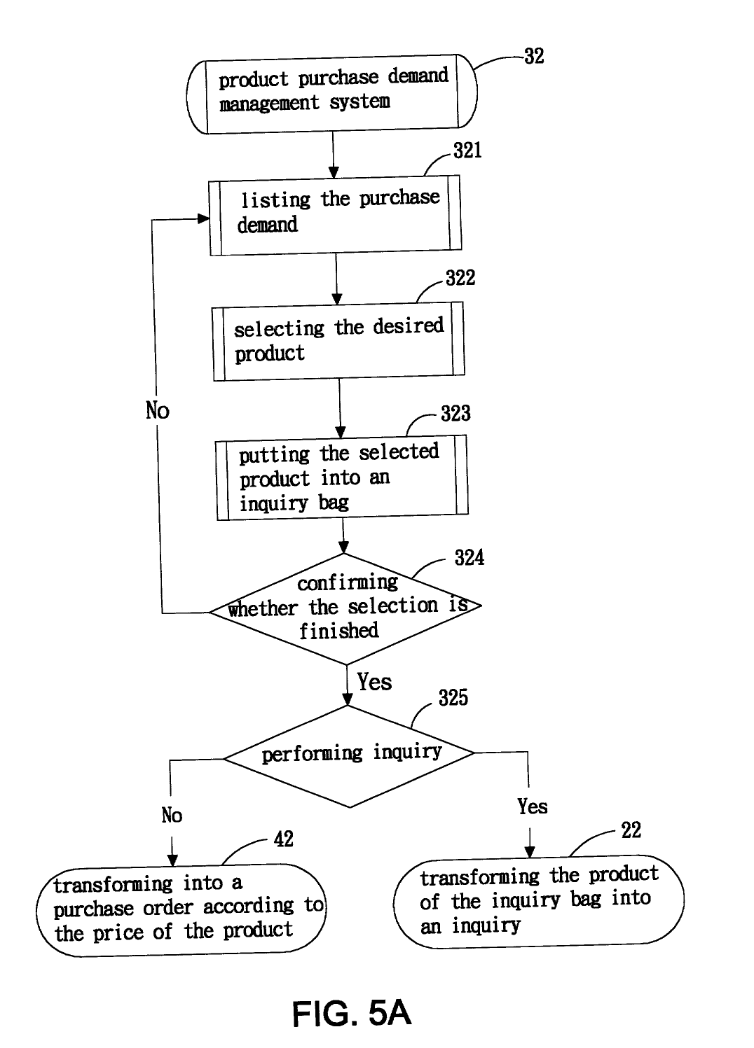

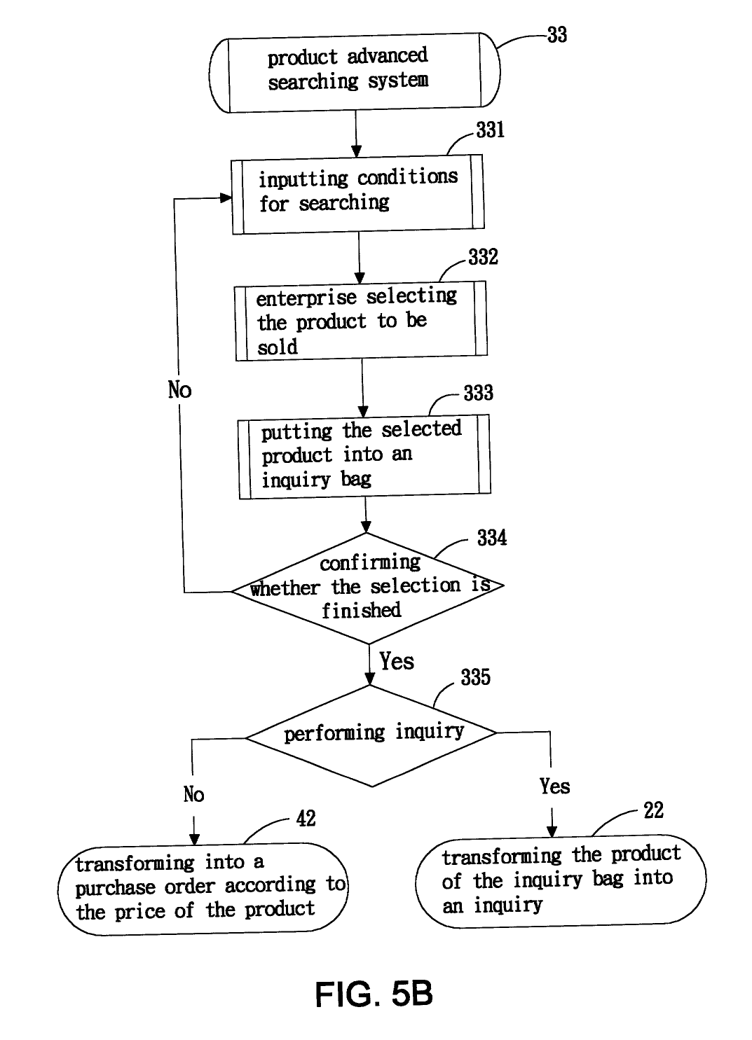

FIG. 5A is a flowchart showing the management of the product purchase demand. The product purchase demand management system 32 is used for the enterprise to watch either the products the clients purchase periodically or the products they can purchase for the client. The products the enterprise purchased would be automatically recorded in the present invention. Alternatively, the client can input the desired products in the product trading management system 31 for the enterprise to provide an inquiry according to the client's demand. The product purchase demand management system 32 is executed in the following steps:

(a) listing all the records saved in the server 1, showing what products are purchased or what the client wants to purchase (step 321);

(b) selecting the product item available and providing an inquiry thereof by the enterprise (step 322);

(c) putting the product item selected into an inquiry bag (step 323).

(d) confirming whether the selection is finished or not. If not finished, then repeat steps (a) to (d). If finished, then go to the next step (step 324); and

(e) transforming the product item of the inquiry bag into the inquiry and saving it in the server 1 to run the inquiry/negotiation process system 22.

FIG. 5B is a flowchart showing the product advanced searching according to the present invention. The client can show the inquiry after the products were arranged according to their demand. The product advanced searching for product arrangement carried out by the client includes:

(a) inputting conditions for searching (step 331). After either inputting a product name or a product code to be arranged, or clicking a product icon to be arranged, all the information about the product is listed;

(b) selecting the product item to be arranged (step 332);

(c) putting the selected product item into the inquiry bag (step 333);

(d) confirming whether the selection is finished or not. If not correct, repeat steps (a) to (d). If correct, then go to the next step (step 334); and

(e) confirming inquiry/negotiation is performed. If yes, then go to step (f). otherwise, go to step (g).

(f) transforming the product item in the inquiry bag into the inquiry and saving it in the server 1 to run inquiry/negotiation process system 22.

(g) transforming the product item in a quotation bag into a purchase order and saving it in the server 1 to run the enterprise purchase order management system 42.

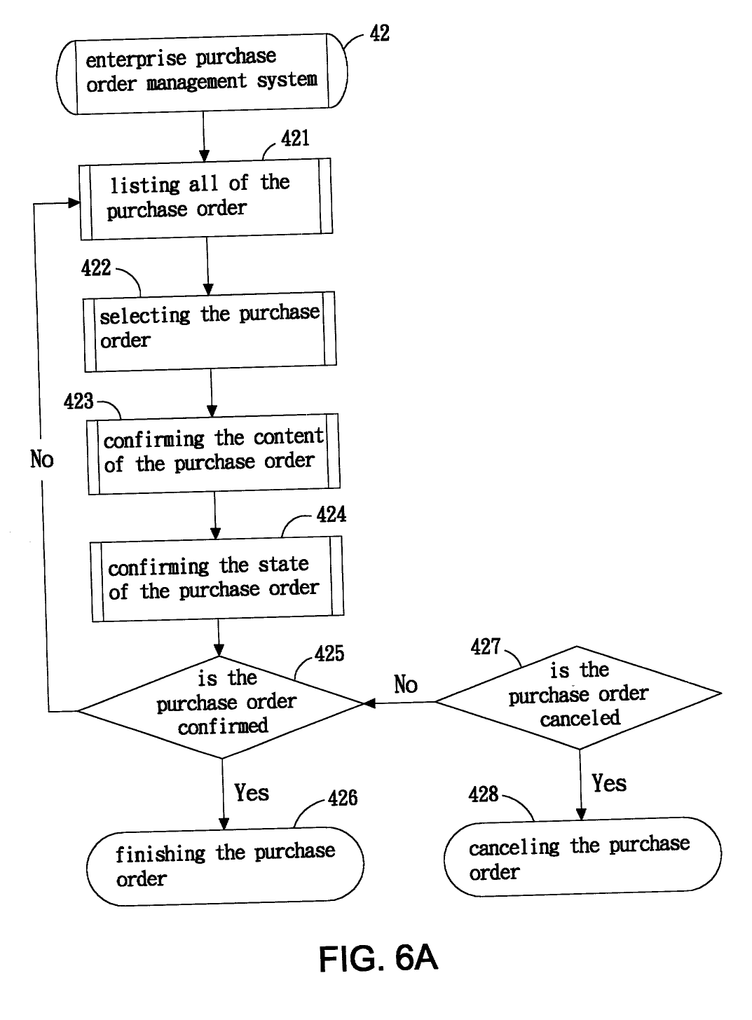

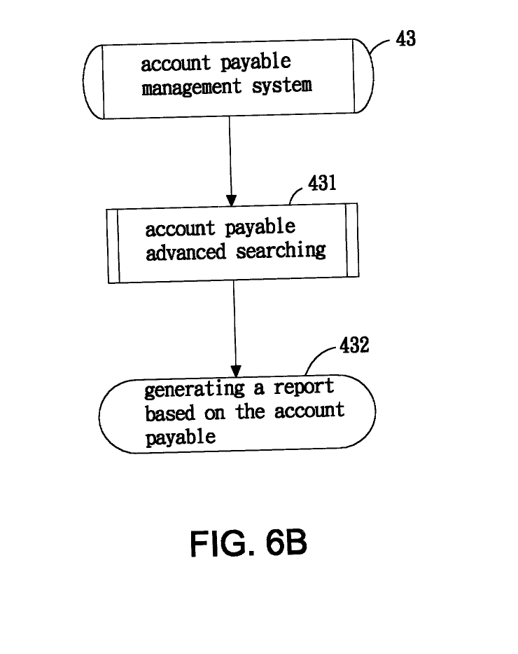

FIG. 6A is a flowchart showing the purchase order management system according to the present invention. The purchase order management system 42 of the present invention is executed in the following steps:

(a) listing all of the purchase order saved in the server 1 (step 421);

(b) selecting the purchase order to be processed (step 422);

(c) confirming the content of the purchase order is correct. If not, then inform the enterprise the incorrect purchase order (step 423);

(d) confirming the state of the purchase purchase order, including whether the purchase order is processed by the enterprise, whether the product is delivered, or whether the account is received (step 424);

(e) if the client has not processed the purchase order yet, then repeat steps (a) to (c) (step 425);

(f) when step (e) is finished, the purchase process is finished (step 426);

(g) at step (d) of confirming state, cancellation of the purchase order is detected automatically. If not canceled, the go to step (e). If canceled, then go to the next step;

(h) canceling the purchase order.

FIG. 6B is a flowchart showing the account receivable management system according to the present invention. With the system of the present invention, an account receivable daily report, a weekly report, a monthly report, a seasonally report or annually report is generated as desired. The client can run the account receivable management system 43 to generate the account receivable report as recited above. The account receivable management system 43 is executed in the following steps of (a) entering account receivable advanced searching to search for daily sale records, weekly sale records, monthly sale records, seasonally sale records, or annually sale records as desired (step 431), and (b) generating the report according to the recorded account receivable (step 432).

The on-line sale process by using a computer according to the present invention provides:

1. selection for differently functional elements as desire to manage replenishment/sales/stock electronically.

2. current clients and potential clients can be controlled to achieve effective management of sales target and enhanced service quality for increase in competitive ability.

3. To communicate with the clients by real-time client management to control sales schedule and achieved percentage of scheduled progress.

4. Graphs and reports are automatically generated to provide judge and analysis for clients' behavior and purchase model.

As understood by a person skilled in the art, the foregoing description of the preferred embodiment and examples of the present invention are only illustrative rather than limiting. Revisions and modifications may be made to processes, materials, and structures through which is provided the foregoing embodiment of the present invention without departing from the spirit and scope of the present invention as defined by the following appended claims.

What is claimed is:

1. An on-line sale system using a computer, wherein a business web site is set up in a server of a enterprise such that the enterprise can go on line to purchase what they want from any one of clients, and wherein the web site mainly has a client trading system that allows a plurality of clients going on line to register their basic information and purchase the products they want to purchase, the client trading system comprising:
an inquiry management system which is a management system for the client to show the enterprise an inquiry;
an inquiry/negotiation management system which manages inquiry/negotiation between the enterprise and the clients;
a product trading management system which is used to manage the products the client wants to purchase; and
a purchase order searching management system which is used for the clients to manage the purchase order.

2. An on-line sale process using the on-line sale system of claim 1, wherein the inquiry management system is executed in steps of:
(a) confirming whether the inquiry is fulfilled or empty. If the inquiry is not empty, then go to step (d). Otherwise, go to the next step;
(b) entering the enterprise product advanced searching. When the client inputs the product name or product code or clicks a product icon, all of the information related to the product are listed;
(c) selecting the product item to be listed on the inquiry this time.
(d) putting the selected product item into an inquiry bag;
(g) confirming whether the selection is finished or not. If not finished, repeat step (b) to step (e). If finished, go to the next step; and
(h) transforming the product item of the inquiry bag into an inquiry, and saving it in the server 1 to run the inquiry/negotiation process system 22.

3. The on-line sale system of claim 1, wherein the inquiry/negotiation management system further comprising:
an inquiry/negotiation process system and
an inquiry/negotiation record management system,
wherein the inquiry/negotiation trading management system allows the client negotiating with the enterprise for the inquiry, and allows the client recording either the inquiry/negotiation in question or special trades as well for other trade or for further re-negotiation.

4. The on-line sale system of claim 1, wherein the product trading management system further comprises:
a product purchase demand system, and
a product advanced searching system, wherein the product trading management system allows the client inquiring about their arranged products after the products are selected and arranged; or wherein the product trading management system allows the client watching which products the enterprise would purchase periodically or which products the enterprise can purchase for the client; or wherein the product trading management system automatically takes down what the client purchased, or the client can input what they need into the product trading management system such that the client can inquire what they want.

5. The on-line sale system of claim 1, wherein the purchase order searching management system further comprising:
an enterprise purchase order management system, and an account receivable management system.

6. An on-line sale process using the on-line sale system of claim 3, wherein the product purchase demand management system is executed in the steps of:
(a) listing all of the inquiries saved in the server 1;
(b) The client selecting the inquiry to be inquired or negotiated;
(c) The client changing the amount and the price of the product item listed on the inquiry;
(d) confirming whether the content of the inquiry is correct. If not correct, then correct the inquiry. If correct, then transform the inquiry into the inquiry/negotiation sheet and save it in the server 1.
(e) confirming whether the enterprise agrees with the inquiry/negotiation sheet. If no, then repeat step (a) to step (e). If yes, then go to the next step;
(f) transforming the inquiry/negotiation sheet into purchase order and saving it in the server 1 to run the enterprise purchase order management system 42.

7. An inquiry/negotiation record management process using the system of claim 3, wherein the inquiry/negotiation record management system allows each client using their “My Favorite” to manage the records of the inquiry/negotiation, the inquiry/negotiation record management comprising:
(a) adding the inquiry/negotiation to “My Favorite”;
(b) clicking the inquiry/negotiation sheet in “My Favorite” to perform inquiry/negotiation;
(c) correcting the inquiry/negotiation sheet in “My Favorite”;
(d) deleting the inquiry/negotiation sheet in “My Favorite”.

8. The inquiry/negotiation process using the on-line sale system of claim 7, wherein adding the inquiry/negotiation to “My Favorite” comprising:
(a) opening “My Favorite”;
(b) listing the inquiry/negotiation sheet saved in the server;
(c) selecting the inquiry/negotiation sheet to be saved;
(d) putting the inquiry/negotiation sheet to be saved into “My Favorite”;
confirming the selection is finished. If not finished, then go to step (a) to (e). If finished, then save “My Favorite” in the server.

9. The inquiry/negotiation process using the on-line sale system of claim 7, wherein clicking the inquiry/negotiation sheet in “My Favorite” comprising:
(a)opening “My Favorite”;
(b)listing the inquiry/negotiation sheet saved in the server 1;
(c)selecting the inquiry/quotation to be traded;
(d)changing the price and the amount of the product item listed in the inquiry/negotiation sheet;
(e)confirming the content of inquiry/negotiation sheet is correct. If not correct, then correct it;
(f)confirming the enterprise agrees the inquiry/negotiation sheet. If no, then repeat step (b) to (f). If yes, then go to next step;
(g)transforming the inquiry/negotiation sheet into a purchase order to run the enterprise purchase order management system.

10. The inquiry/negotiation process using the on-line sale system of claim 7, wherein changing the inquiry/negotiation sheet in “My Favorite” comprising:
(a) opening “My Favorite”;
(b) listing the inquiry/negotiation sheet saved in the server 1;
(c) selecting the inquiry/inquiry to be changed;
(d) changing the price and the amount of the product item listed in the inquiry/negotiation sheet;
(e) confirming the selection is finished or not. If not finished, then repeat steps (b) to (e). If finished, then save “My Favorite” in the server;
(f) finishing “correct”.

11. The inquiry/negotiation process using the on-line sale system of claim 7, wherein the deleting the inquiry/negotiation sheet in “My Favorite comprising:
(a) opening “My Favorite”;
(b) listing the inquiry/negotiation sheet saved in the server;
(c) selecting the inquiry/negotiation sheet to be deleted;
(d) deleting the inquiry/negotiation sheet;
(e) confirming the selection is finished. If not finished, then go to step (b) to (e). If finished, then save “My Favorite” in the server;
(f) finishing “delete”.

12. A product purchase demand management process using the purchase order searching management system of claim 4, wherein the product purchase demand management system is executed in steps of:
(a) listing all of the product item the clients purchased or the product item the clients need to purchase;
(b) selecting the product item to be sold or quoted;
(c) putting the selected product item into an inquiry bag;
(d) confirming the selection is finished. If not finished, then repeat steps (a) to (d). If finished, then go to next step;
(e) transforming the product item in the inquiry bag into an inquiry to run the inquiry/negotiation process system.

13. A product purchase demand management process using the purchase order searching management system of claim 4, wherein the product advanced searching comprising:
(a) inputting conditions for searching. After whether inputting a product name or a product code to be arranged, or clicking a product icon to be arranged, all the information about the product is listed;
(b) selecting the product item to be arranged;
(c) putting the selected product item into the inquiry bag;
(d) confirming whether the selection is finished or not. If not finished, then repeat steps (a) to (d). If finished, then go to the next step;
(e) transforming the product item in the inquiry bag into the inquiry and saving it in the server to run inquiry/negotiation process system.

14. An purchase order searching management process using the purchase order searching management system of claim 5, comprising:
(a) listing all of the purchase order sheets saved in the server;
(b) selecting the purchase order to be processed;
(c) confirming the content of the purchase order is correct. If not correct, then inform the enterprise of the incorrect purchase order;
(d) confirming the state of the purchase order, including whether the purchase order is processed, whether the product is delivered, or whether the account is received;
(e) if the purchase order has not been processed yet, then repeat steps (a) to (c); if the product has not been conveyed, then inform the material system to convey the product; if the account has not been received yet, then inform the client to pay;
(f) when step (e) is finished, then the purchase process is finished.

15. The purchase order searching management process of claim 14, wherein in step (d) of confirming state, cancel of the purchase order is detected automatically; if the purchase order doesn't be canceled, then go to step (e); otherwise the purchase order is canceled.

16. An purchase order searching management process using a purchase order searching management system of claim 5, wherein the account receivable management system is executed in steps of:
(a) entering account receivable advanced searching system to search for daily sale records, weekly sale records, monthly sale records, seasonally sale records, or annually sale records as desired, and
(b) generating the report according to the recorded account receivable.
